(19) United States
(12) Patent Application Publication
(10) Pub. No.: US 2015/0082443 A1
(43) Pub. Date: Mar. 19, 2015

(54) SYSTEM TO AUTOMATE COMPLIANCE WITH LICENSES OF SOFTWARE THIRD-PARTY CONTENT

(71) Applicant: GOOGLE INC., Mountain View, CA (US)

(72) Inventors: Evan Scott BEHAR, Arlington, VA (US); Daniel BERLIN, Mountain View, CA (US)

(73) Assignee: GOOGLE INC., Mountain View, CA (US)

(21) Appl. No.: 14/026,823

(22) Filed: Sep. 13, 2013

(51) Int. Cl. G06F 21/10

(52) U.S. Cl. CPC G06F 21/105
USPC 726/26

(57) ABSTRACT

A method to automate compliance with software package content licenses is disclosed. The method may generate a dependency graph for a software product's package code by creating nodes only for software packages upon which run-time code depends. Software package content license lists may be propagated through the generated dependency graph. License notice files may be generated based on the propagated license lists.

### BACKGROUND

Software products may use functionality of already-written code by incorporating software packages into their source code. When a software product contains software packages, the finished software product often must include the license under which these packages were obtained and expose the licenses to the finished software product's end users. There may be significant legal consequences if software products or the products' end users fail to comply with these licenses.

It may be difficult and/or time consuming to manually determine all the required licenses for a software product due to the number of packages incorporated within the product. Additionally, a manual determination may produce an inaccurate listing of all required licenses. As recognized by the inventors, there should be a system that automatically generates required license notices for software packages that are included in a given software product.

### SUMMARY

This specification describes technologies relating to compliance with licenses of software package content in general and specifically to a system and method of automatically generating required license notices for software packages included in a software product's code.

In general, one aspect of the subject matter described in this specification can be embodied in a system and method to automate compliance with software package content licenses. An exemplary system may include on or more processing devices and one or more storage devices storing instructions that, when executed by the one or more processing devices, cause the one or more processing devices to perform an exemplary method. An exemplary method may include: generating a dependency graph for a software product's package code; propagating software package content license lists through the generated dependency graph; and generating license notice files based on the propagated license lists.

These and other embodiments can optionally include one or more of the following features: the step of generating a dependency graph for a software product's package may include creating nodes only for software packages upon which run-time code depends; a dependency graph may include at least one directed edge from a package node to the package's predecessor; the step of propagating software package content license lists through the generated dependency graph may include each node in the graph sending its license list to its predecessors; license lists may specify pairs of package names and license files in the form: <package-name, license-file>; each node may receive one update message along an incoming edge that includes a license list from its descendent on that edge; license lists may be merged as they propagate upward; each node may send an update message when the node has received messages from all incoming edges associated with the node; and the directed edge may be annotated with a propagation cause.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is an example directed graph representing an example main package dependency graph.

FIG. 2 is a flow diagram of an exemplary method for automating compliance with included software package content licenses.

FIG. 3 is a flow diagram of an exemplary method for message passing in an exemplary directed graph.

FIG. 4 is a block diagram illustrating an exemplary computing device.

FIG. 5 is an example software build file.

### DETAILED DESCRIPTION

According to an exemplary embodiment, a system may generate required license notices for included software packages that are included in a software product's final object code. License notice generation for a software package may include: (1) generating a dependency graph by creating nodes for all immediate run-time dependencies of the software product; (2) propagating licenses through the dependency graph; and (3) generating the license notice files.

When creating a software product, a software developer may write code in a particular programming language to create the software product's functionality. This code may be referred to as source code. In order for a computer to execute the code, the source code must be “built,” meaning that the source code files need to be converted into standalone software artifacts that can be run on a computer. A build file may describe how to build and package software for execution. An important part of the build process is compiling the source code into object code which is in a machine readable language.

Sometimes software developers include software packages in their source code so that they can incorporate additional functionality without having to write the code functionality themselves. As discussed above, these software packages often have licenses with which end users should comply in order to use the functionality. If a software product contains functionality under license, the license should be displayed to the end users of the software product. In some embodiments, end users may be able to respond to the license agreements from this display.

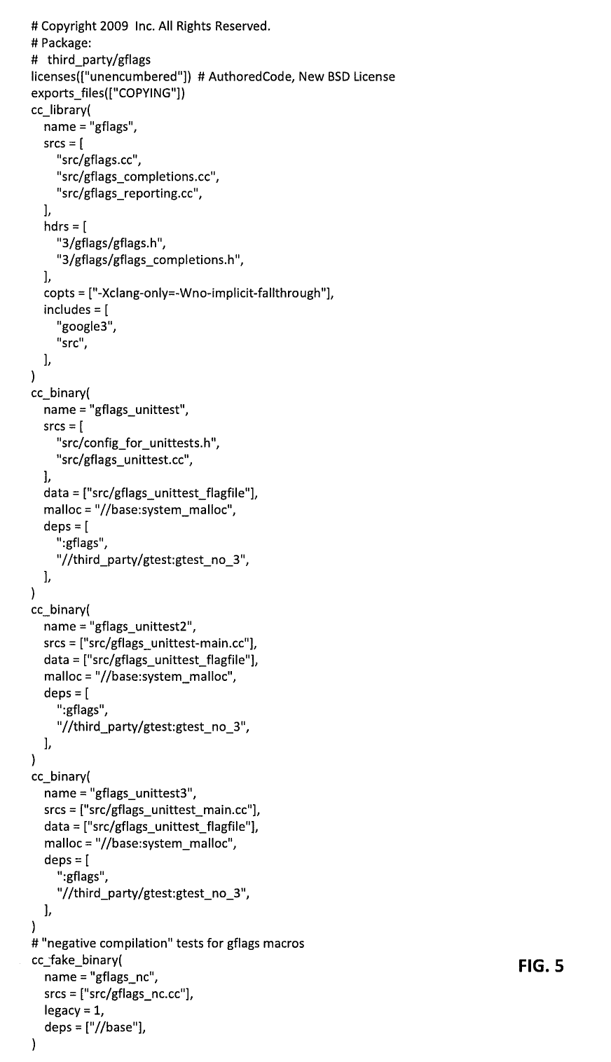

In order to display the correct licenses for a software product, an exemplary system may determine the software packages upon which the software product depends. Each software package included in a software product may contain a build file which indicates other software packages upon which the package depends. An example build file is illustrated in FIG. 5. Software package dependencies may be analyzed to find the software packages upon which they depend.

A build file dependency analysis may not be entirely accurate in determining dependencies since build files may contain dependencies that are not part of the final run-time object code. For instance, a build file may specify that the code depends upon a particular compiler which may be used to compile part of the software build. However, the compiler may only be used to compile the source code and may not actually be incorporated into the final object code. If a software package is not part of the final object code, the inclusion of a license for the software package is not necessary.

In order to determine which packages must have licenses, an exemplary system may analyze a software product's source code for included source files from other packages and for identifiers which are defined in those source files. Run-time dependencies may be found in source code by checking all defined identifiers in an application's source code and matching the identifiers against files which come from source code for software packages that are external to the application. These files are then searched for identifiers from external packages until files are found consisting entirely of either internal symbols or symbols from external packages that have already been searched. In some embodiments, an exemplary method may search the intermediate object code for software files to match the found identifiers with those in the object code to cull out defined symbols that are not actually used in the application's binary.

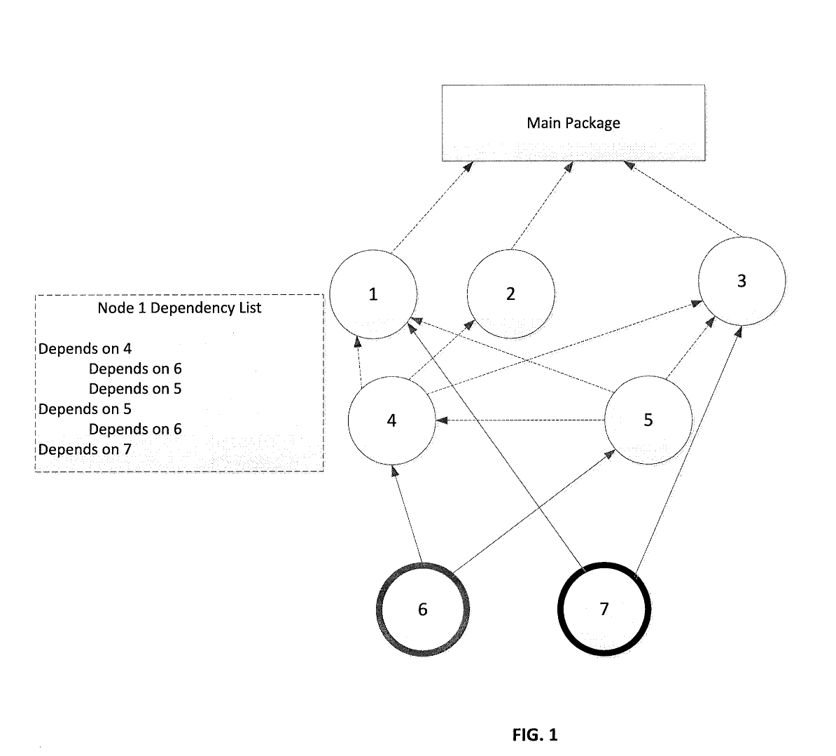

A directed dependency graph may be constructed to represent dependencies as shown in FIG. 1. A directed dependency graph is a data structure that stores data and shows relationships among data using a finite collection of points, called vertices or nodes, and lines, called edges. Relationships within the graph are represented by connecting vertices with each other using edges. An exemplary system may use a graph-based programming model such as the Pregel programming model in order to create the dependency graph.

The Pregel model is used for large-scale graph processing and takes input that is a directed graph in which each vertex is uniquely identified by a string vertex identifier. Each vertex is associated with a modifiable, user-defined value. The directed edges are associated with their source vertices, and each edge consists of a modifiable, user-defined value and a target vertex identifier. The Pregel model generally involves expressing graphs as a sequence of iterations, in each iteration a vertex can receive messages sent in the previous iteration, send messages to other vertices, and/or modify its own state and the state of its outgoing edges or mutate graph topology.

In an exemplary system, each vertex in a graph may represent a software package and each directed edge may represent a dependency relationship. A graph node is represented initially as a software product's main package. Graph nodes are then created for the main package's immediate dependencies. As illustrated in FIG. 1, the main package is dependent upon packages 1, 2, and 3. Package 1 is dependent on packages 4, 5, and 7, package 2 is dependent on package 4, and package 3 is dependent on packages 4, 5, and 7. Packages 4 and 5 are both dependent on package 6. The graph may propagate across all dependencies. When the graph propagation terminates, the graph nodes may be a complete set of dependencies of the software product. Dependency lists cannot contain any duplicate package names. Using the example of FIG. 1, even though both package 1 and 3 are dependent on package 7, package 7 will only appear once in the dependency list for the main package.

An exemplary system may construct a directed dependency graph so that each package in the graph contains an outgoing edge to the package's predecessor rather than the package's descendent. Using this construction, each directed edge in the graph represents the “required-by” relationship. Specifically, if node A has an outgoing edge that points to node B, then node A is required by node B. Node A may propagate the licenses of its dependencies up to node B, but node B may not send information to node A. In FIG. 1, package 7 has outgoing edges that point to both the node for package 1 and the node for package 2. Package 7 may propagate its licenses and those of its dependencies up to the nodes for package 1 and package 3.

An exemplary system may propagate license information from sources to the software product's main package. Each node in the graph may send its license list to its predecessors. License lists may be specified as pairs of package names and license files in the form: <package-name, license-file>. License lists may be merged as they propagate upward until each node has received a list from all of its descendants with duplicate list entries being removed.

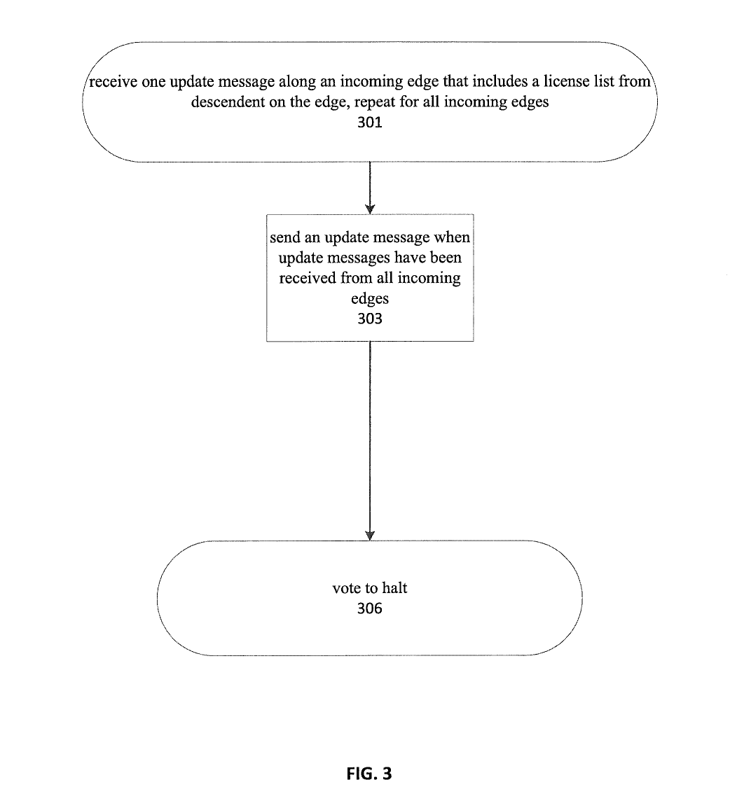

Each node may receive one update message along each of its incoming edges that includes the license list from its descendent on that edge as illustrated in FIG. 3 (301). In order to guarantee completeness of a node's outgoing update message containing the node's license list, no node should send an update message until the node has received all of its incoming edge messages (303). Once a node has sent its update message, the node will vote to halt (306). Voting to halt means that the node has no further work to do unless it receives a further message. Subsequent nodes will wait until they have received all incoming edge messages before propagating their messages and voting to halt. Nodes send out messages, then vote to halt and become inactive. When they receive further messages, the nodes transition back to active. Message passing will terminate when all nodes have sent their update messages. Complete computation terminates when all nodes have voted to halt and become inactive.

Once the graph algorithm finishes, the dependency list for each node may be emitted as part of one or more files. Each list entry in the form of a <package-name, license-file> pair for a given package may be converted into an entry in an HTML file that specifies the package's full name, author, and a link to the actual license file or license string in the build.

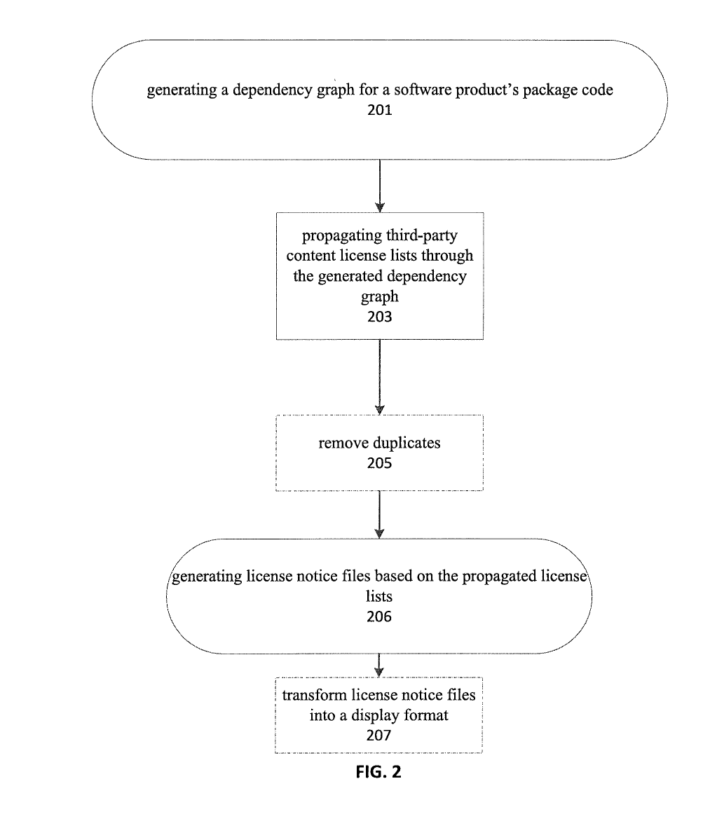

An exemplary method for automating compliance with included software package content licenses begins with generating a dependency graph for a software product's package code as illustrated in FIG. 2 (201). Nodes are created only for software packages upon which run-time code depends. Software package content license lists are then propagated through the generated dependency graph (203) and license notice files are generated based on the propagated license lists (206).

In addition, causal chaining may be used to update a dependency graph with a propagation cause. Edges of the graph may be annotated with the details about what caused propagation. In particular, the build action that caused propagation may be included. Edge information may track the action, such as compilation or linking, that caused propagation along an edge. This information may be used to understand why a file or package required a certain license. The information may also be used to verify the implications of various licenses, for example that a certain license is only dynamically linked.

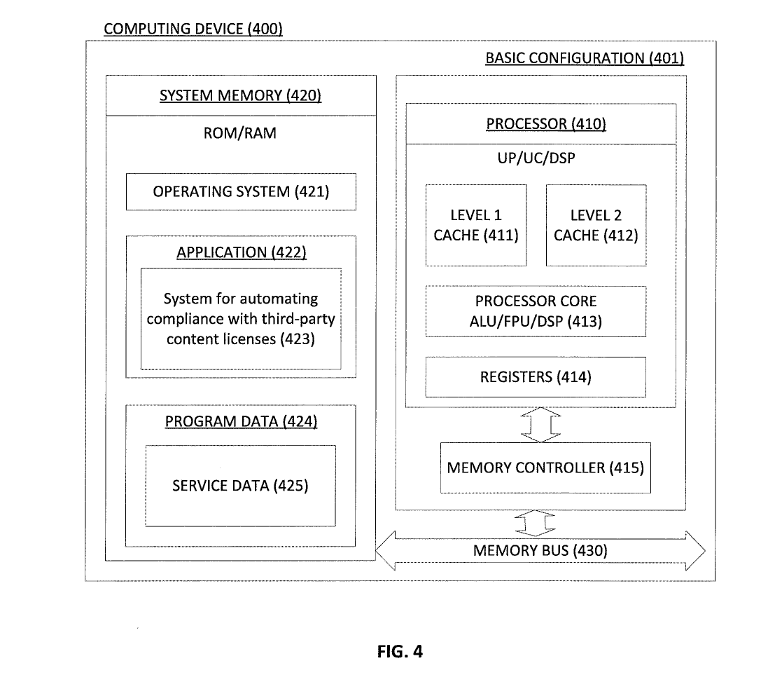

FIG. 4 is a high-level block diagram of an exemplary computer (400) that is arranged for automating compliance with included content licenses. In a very basic configuration (401), the computing device (400) typically includes one or more processors (410) and system memory (420). A memory bus (430) can be used for communicating between the processor (410) and the system memory (420).

Depending on the desired configuration, the processor (410) can be of any type including but not limited to a microprocessor (μP), a microcontroller (μC), a digital signal processor (DSP), or any combination thereof The processor (410) can include one more levels of caching, such as a level one cache (411) and a level two cache (412), a processor core (413), and registers (414). The processor core (413) can include an arithmetic logic unit (ALU), a floating point unit (FPU), a digital signal processing core (DSP Core), or any combination thereof. A memory controller (416) can also be used with the processor (410), or in some implementations the memory controller (415) can be an internal part of the processor (410).

Depending on the desired configuration, the system memory (420) can be of any type including but not limited to volatile memory (such as RAM), non-volatile memory (such as ROM, flash memory, etc.) or any combination thereof. System memory (420) typically includes an operating system (421), one or more applications (422), and program data (424). The application (422) may include a system for determining the user's time zone for automating compliance with included software package content licenses. Program Data (424) includes storing instructions that, when executed by the one or more processing devices, implement a system and method for automating compliance with included content licenses. (423). In some embodiments, the application (422) can be arranged to operate with program data (324) on an operating system (421).

The computing device (400) can have additional features or functionality, and additional interfaces to facilitate communications between the basic configuration (401) and any required devices and interfaces.

System memory (420) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media can be part of the device (400).

The computing device (400) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (400) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method to automate compliance with software package content licenses, the method comprising:
generating a dependency graph for a software product's package code;
propagating software package content license lists through the generated dependency graph; and
generating license notice files based on the propagated license lists.

2. The method of claim 1, said generating a dependency graph for a software product's package code step includes creating nodes only for software packages upon which run-time code depends.

3. The method of claim 1 wherein the dependency graph includes at least one directed edge from a package node to the package's predecessor.

4. The method of claim 1, said propagating software package content license lists through the generated dependency graph step including each node in the graph sending its license lists to its predecessors.

5. The method of claim 1, further comprising license lists specifying pairs of package names and license files in the form: <package-name, license-file>.

6. The method of claim 2, further comprising each node receiving one update message along an incoming edge that includes a license list from its descendent on that edge.

7. The method of claim 1, further comprising merging license lists as they propagate upward.

8. The method of claim 6, further comprising each node sending an update message when the node has received messages from all incoming edges associated with the node.

9. The method of claim 1, further comprising annotating the directed edge with a propagation cause.

10. A system to automate compliance with software package content licenses, the system comprising:
one or more processing devices and
one or more storage devices storing instructions that, when executed by the one or more processing devices, cause the one or more processing devices to:
generate a dependency graph for a software product's package code;
propagate software package content license lists through the generated dependency graph; and
generate license notice files on the propagated license lists.

11. The system of claim 10, said generate a dependency graph for a software product's package code step includes creating nodes only for software packages upon which run-time code depends.

12. The system of claim 10 wherein the dependency graph includes at least one directed edge from a package node to the package's predecessor.

13. The system of claim 10, said propagate software package content license lists through the generated dependency graph step including each node in the graph sending its license lists to its predecessors.

14. The system of claim 10, further comprising license lists specifying pairs of package names and license files in the form: <package-name, license-file>.

15. The system of claim 11, further comprising each node receiving one update message along an incoming edge that includes a license list from its descendent on that edge.

16. The system of claim 10, further comprising merging license lists as they propagate upward.

17. The system of claim 15, further comprising each node sending an update message when the node has received messages from all incoming edges associated with the node.

18. The system of claim 10, further comprising annotating the directed edge with a propagation cause.
